(19) United States
(12) Patent Application Publication
(10) Pub. No.: US 2026/0116470 A1
(43) Pub. Date: Apr. 30, 2026

(54) VEHICLE FRONT STRUCTURE

(71) Applicants: HYUNDAI MOTOR COMPANY, Seoul (KR); KIA CORPORATION, Seoul (KR)

(72) Inventors: Hyun Wook Park, Hwaseong-si (KR); Kun Ho Park, Hwaseong-si (KR)

(73) Assignees: HYUNDAI MOTOR COMPANY, Seoul (KR); KIA CORPORATION, Seoul (KR)

(21) Appl. No.: 19/188,604

(22) Filed: Apr. 24, 2025

(30) Foreign Application Priority Data
Oct. 31, 2024 (KR) 10-2024-0152951

(51) Int. Cl. B62D 21/15; B62D 21/11

(52) U.S. Cl. CPC B62D 21/152; B62D 21/11

(57) ABSTRACT

A vehicle front structure includes: a front side member extending in a longitudinal direction of a vehicle; a mounting plate attached to a front end of the front side member; a connection member connecting the mounting plate and the front side member; a mounting bracket protruding from the front side member toward the interior of the vehicle; and a power electronics (PE) module connected to the mounting bracket.

### CROSS-REFERENCE TO RELATED APPLICATION

This application is based on and claims the benefit of and priority to Korean Patent Application No. 10-2024-0152951, filed on Oct. 31, 2024, in the Korean Intellectual Property Office, the disclosure of which is incorporated herein in its entirety by reference.

### TECHNICAL FIELD

The present disclosure relates to a vehicle front structure designed to absorb impact energy during a vehicle collision or impact.

### BACKGROUND

Vehicles are tested to evaluate crashworthiness by conducting various tests, including frontal impact tests, side impact tests, rear impact tests, and roll-over tests. Recently, small overlap crash tests (simulations of small overlap frontal crashes against a rigid barrier) have been introduced by the Insurance Institute for Highway Safety (IIHS).

An electric vehicle may be designed to induce a lateral displacement of the vehicle during a small-overlap crash, thereby reducing vehicle body damages, passenger injuries, battery damages, and the like.

In order to induce the lateral displacement of the vehicle, the electric vehicle according to the related art may include a bumper deflector provided on an end of a front bumper, a side deflector provided on a front side member, and a cross bar connecting the pair of front side members in a width direction of the vehicle. Accordingly, in the event of a vehicle collision/impact, a load may be transferred to the cross bar through the bumper deflector and the side deflector so that the lateral displacement of the vehicle may be induced.

However, as the related art electric vehicle requires the bumper deflector, the side deflector, and the cross bar for the lateral displacement of the vehicle, the front structure thereof may become complex, and the weight and manufacturing cost thereof may be relatively increased. In addition, the cross bar may be made of an aluminum material to enhance fracture properties compared to steel, which relatively increases the manufacturing cost.

The above information described in this background section is provided to assist in understanding the background of the inventive concept, and may include any technical concept which is not considered as the prior art that is already known to those having ordinary skill in the art.

### SUMMARY

The present disclosure has been made to solve the above-mentioned problems occurring in the prior art while advantages achieved by the prior art are maintained intact.

An aspect of the present disclosure provides a vehicle front structure designed to induce a lateral displacement of the vehicle in the event of a vehicle collision/impact without additional components such as a bumper deflector, a side deflector, and a cross bar.

According to an aspect of the present disclosure, a vehicle front structure may include: a front side member extending in a longitudinal direction of a vehicle; a mounting plate attached to a front end of the front side member; a connection member connecting the mounting plate and the front side member; a mounting bracket protruding from the front side member toward an interior of the vehicle; and a power electronics (PE) module connected to the mounting bracket.

The vehicle front structure may further include a bulkhead disposed in the front side member and aligned with the mounting bracket.

An inboard-side flange of the connection member may be fixed to an outboard wall of the front side member.

The inboard-side flange of the connection member may be connected to the bulkhead.

In an embodiment, a front bumper may be connected to a front surface of the mounting plate, and the front side member and the connection member may be fixed to a rear surface of the mounting plate.

In an embodiment, the mounting plate may include an inboard-side mounting portion facing the interior of the vehicle and an outboard-side mounting portion facing an exterior of the vehicle. The front side member may be fixed to the inboard-side mounting portion of the mounting plate, and the connection member may be fixed to the outboard-side mounting portion of the mounting plate.

In an embodiment, the vehicle front structure may further include a front subframe connected to a bottom end of the connection member. The front subframe may have a cross portion extending in a width direction of the vehicle.

In an embodiment, the mounting bracket may include a support wall extending from the inboard wall of the front side member toward the PE module, and a mounting flange connected to the support wall. The mounting flange may be fixed to an outer surface of the inboard wall of the front side member.

In an embodiment, the bulkhead may include a mounting plate fixed to an inner surface of the inboard wall of the front side member, and a support bracket extending from the mounting plate of the bulkhead toward the outboard wall of the front side member.

The support bracket may include a support wall extending from the mounting plate of the bulkhead toward the outboard wall of the front side member, and a mounting flange connected to the support wall. The mounting flange may be fixed to an inner surface of the outboard wall of the front side member.

An inboard-side flange of the connection member may be connected to the mounting flange of the support bracket.

The mounting bracket has a width that gradually decreases from the front side member toward the PE module.

The connection member, the bulkhead, the mounting bracket, and the PE module may be connected to define a load transfer path.

In an embodiment of the present disclosure, a vehicle front structure comprises: a front side member including an inboard wall and an outboard wall, each extending in a longitudinal direction of a vehicle and; and a mounting plate attached to a front end of the front side member. The vehicle front structure further comprises: a connection member connecting the mounting plate and the front side member; at least one mounting bracket attached to the inboard wall in a direction perpendicular to the longitudinal direction of the vehicle and connected to a power electronics (PE) module; and a bulkhead positioned within an interior space defined by the inboard wall and the outboard wall, wherein the bulkhead is aligned with the at least one mounting bracket and configured to form a load path from a bumper to the PE module via the connection member and the mounting bracket.

In an embodiment, the vehicle front structure further comprises: a front subframe connected to a bottom end of the connection member such that an impact load is transferred from the bumper to the front subframe 16 through the connection member.

In another embodiment, the connection member is configured to transfer a load input from the bumper to the PE module through the bulkhead and the at least one mounting bracket so that a load transfer direction during a vehicle collision is changed from the longitudinal direction of the vehicle to a width direction of the vehicle along the load path.

### BRIEF DESCRIPTION OF THE DRAWINGS

The above and other objects, features and advantages of the present disclosure should be more apparent from the following detailed description taken in conjunction with the accompanying drawings:

FIG. 1 illustrates a plan view of a vehicle front structure according to an embodiment of the present disclosure;

FIG. 2 illustrates a portion of the vehicle front structure as viewed in the direction indicated by arrow A-A of FIG. 1;

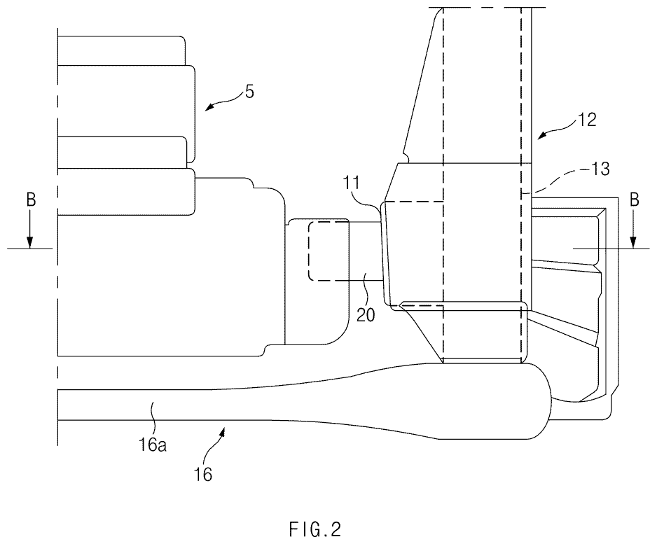

FIG. 3 illustrates a cross-sectional view, taken along line B-B of FIG. 2;

FIG. 4 illustrates a perspective view as viewed in the direction indicated by arrow C of FIG. 1;

FIG. 5 illustrates a perspective view as viewed in the direction indicated by arrow D of FIG. 4;

FIG. 6 illustrates a plan view of a mounting bracket and a reinforcing member in a vehicle front structure according to an embodiment of the present disclosure; and

FIG. 7 illustrates a perspective view of a mounting bracket and a reinforcing member in a vehicle front structure according to an embodiment of the present disclosure.

### DETAILED DESCRIPTION

Hereinafter, some embodiments of the present disclosure are described in detail with reference to the accompanying drawings. In the drawings, the same reference numerals are used throughout to designate the same or equivalent elements. In addition, a detailed description of well-known techniques associated with the present disclosure have been ruled out in order not to unnecessarily obscure the gist of the present disclosure.

Terms such as first, second, A, B, (a), and (b) may be used to describe the elements in embodiments of the present disclosure. These terms are only used to distinguish one element from another element, and the intrinsic features, sequence or order, and the like of the corresponding elements are not limited by the terms.

Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

When a component, device, element, or the like of the present disclosure is described as having a purpose or performing an operation, function, or the like, the component, device, or element should be considered herein as being “configured to” meet that purpose or to perform that operation or function.

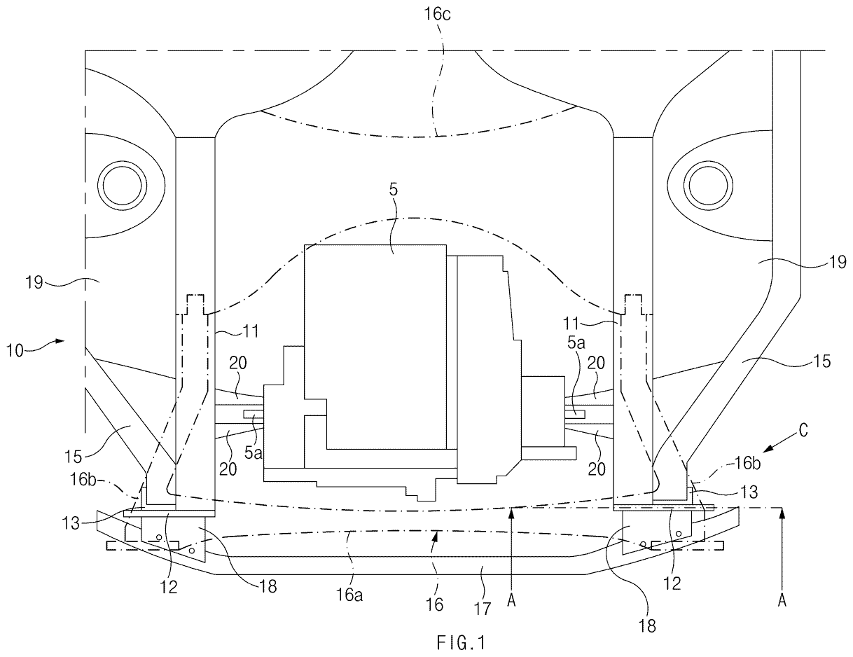

Referring to FIG. 1, according to an embodiment of the present disclosure, a vehicle front structure 10 may include: a pair of front side members 11 extending in a longitudinal direction of the vehicle, a pair of mounting plates 12 attached to front ends of the pair of front side members 11, and a pair of connection members 13 attached to the pair of mounting plates 12.

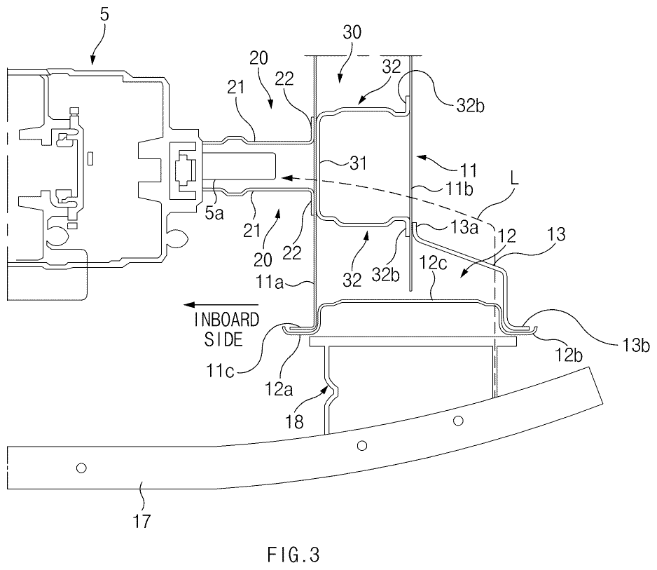

Each front side member 11 may extend in the longitudinal direction of the vehicle, and the pair of front side members 11 may be spaced apart from each other in a width direction of the vehicle. Referring to FIG. 3, each front side member 11 may include an inboard wall 11a facing the interior of the vehicle, and an outboard wall 11b facing the exterior of the vehicle. In addition, the front side member 11 may include a top wall facing the top of the vehicle, and a bottom wall facing the bottom of the vehicle. Each front side member 11 may have a cavity defined therein, and the cavity may be defined by the top wall, the bottom wall, the inboard wall 11a, and the outboard wall 11b.

A power electronics (PE) module 5 may be disposed between the pair of front side members 11. The PE module 5 may include an electric motor, an inverter, and the like. The PE module 5 may be located in the interior of the vehicle, and the PE module 5 may be connected to the inboard wall 11a of the front side member 11. The PE module 5 may connect the pair of front side members 11 in the width direction of the vehicle so that the PE module 5 may define a lateral load path in the width direction of the vehicle.

Each mounting plate 12 may be attached to the front end of the corresponding front side member 11, and the mounting plate 12 may have a cross-sectional area greater than a cross-sectional area of the front side member 11. In particular, each mounting plate 12 may extend in a height direction of the vehicle. The mounting plate 12 may extend between a front portion of a front subframe 16 and a front portion of a fender apron member 15 in the height direction of the vehicle.

Referring to FIG. 3, a front bumper 17 may be connected to front surfaces of the pair of mounting plates 12 through a pair of crash boxes 18, and each front side member 11 and each connection member 13 may be fixed together to a rear surface of the corresponding mounting plate 12. Accordingly, the connection member 13 may connect the front bumper 17 and the front side member 11 through the crash box 18 and the mounting plate 12 so that the connection member 13 may transfer a load from the front bumper 17 to the front side member 11.

The front bumper 17 may be connected to the pair of front side members 11 through the pair of crash boxes 18 and the pair of mounting plates 12. The pair of crash boxes 18 may be connected to the pair of mounting plates 12, respectively. A front end of each crash box 18 may be fixed to the front bumper 17, and a rear end of the crash box 18 may be fixed to the front surface of the corresponding mounting plate 12. Accordingly, the front bumper 17 may be connected to the front surface of the corresponding mounting plate 12 through the crash box 18.

Referring to FIG. 3, each mounting plate 12 may have an inboard-side mounting portion 12a facing the interior of the vehicle and an outboard-side mounting portion 12b facing the exterior of the vehicle. In addition, each mounting plate 12 may have a protruding portion 12c protruding toward the front side member 11 and the connection member 13, and the protruding portion 12c of the mounting plate 12 may be inserted into the front portion of the front side member 11 and the connection member 13.

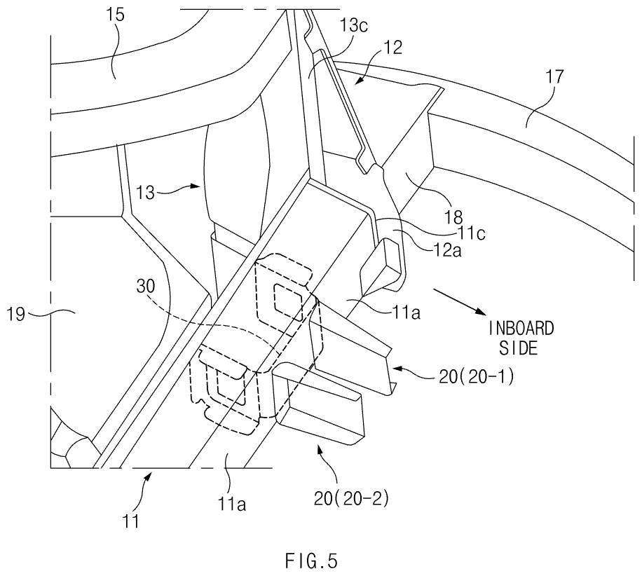

Referring to FIGS. 3 and 5, a front flange 11c of the front side member 11 may be fixed to the inboard-side mounting portion 12a of the mounting plate 12 using fasteners, welding, and/or the like. As illustrated in FIG. 5, each front side member 11 may be aligned with the corresponding crash box 18 and the inboard-side mounting portion 12a of the corresponding mounting plate 12 in the longitudinal direction of the vehicle. Accordingly, the load input to the front bumper 17 may be transferred to the front side member 11 through the mounting plate 12.

The front subframe 16 may be disposed below the pair of front side members 11, and the front subframe 16 may be connected to the connection member 13, the front side member 11, a dash panel, and the like. The front subframe 16 may be configured to support the PE module 5 and the other components located between the pair of front side members 11.

Each connection member 13 may extend between the front portion of the front subframe 16 and the front portion of the corresponding fender apron member 15 in the height direction of the vehicle. The connection member 13 may be configured to connect the mounting plate 12, the front side member 11, and the PE module 5. Each connection member 13 may have an inboard-side flange 13a facing the interior of the vehicle and an outboard-side flange 13b facing the exterior of the vehicle.

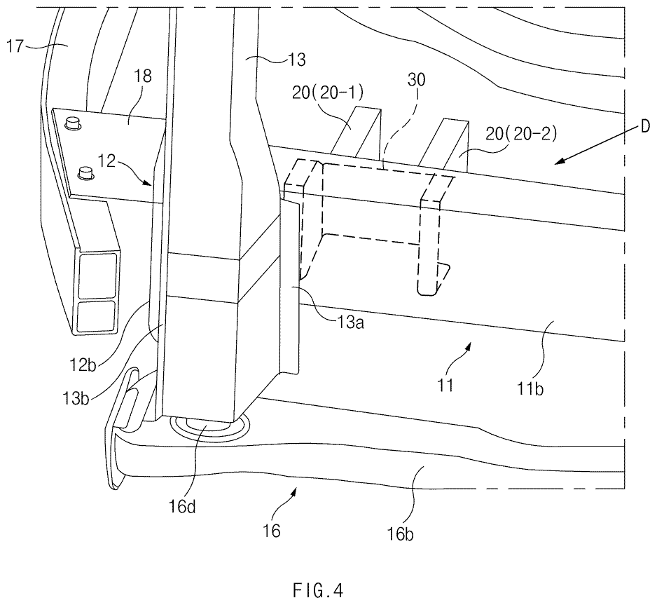

Referring to FIGS. 3 and 4, the outboard-side flange 13b of the connection member 13 may be fixed to the outboard-side mounting portion 12b of the mounting plate 12 using fasteners, welding, and/or the like. Each connection member 13 may be aligned with the corresponding crash box 18 and the outboard-side mounting portion 12b of the corresponding mounting plate 12. The inboard-side flange 13a of the connection member 13 may be fixed to the outboard wall 11b of the front side member 11 using fasteners, welding, and/or the like. Accordingly, the load input to the front bumper 17 may be transferred to the front side member 11 through the mounting plate 12 and the connection member 13.

Referring to FIG. 1, the front subframe 16 may include: a front cross portion 16a extending in the width direction of the vehicle, a pair of side portions 16b extending from both ends of the front cross portion 16a along the longitudinal direction of the vehicle, and a rear cross portion 16c located behind the front cross portion 16a.

The front subframe 16 may have a pair of front mounts 16d. Referring to FIG. 4, each front mount 16d of the front subframe 16 may be mounted on a bottom end of the corresponding connection member 13. Accordingly, in the event of a small overlap crash of the vehicle, the load may be transferred from the front bumper 17 to the front cross portion 16a of the front subframe 16 through the connection member 13 so that a lateral displacement of the vehicle may be stably induced.

Referring to FIG. 1, the pair of fender apron members 15 may be connected to the pair of connection members 13, respectively. Each fender apron member 15 may extend in the longitudinal direction of the vehicle. Referring to FIG. 5, the front portion of each fender apron member 15 may be fixed to a top end of the corresponding connection member 13. Accordingly, in the event of a small overlap crash of the vehicle, the load may be transferred from the front bumper 17 to the fender apron member 15 through the connection member 13 so that the load may be transferred through the fender apron member 15 in the longitudinal direction of the vehicle.

Referring to FIG. 1, a pair of damper housings 19 may be connected to the pair of fender apron members 15, respectively. A top edge portion of each damper housing 19 may be fixed to the corresponding fender apron member 15 using fasteners, welding, and/or the like, and a bottom edge portion of each damper housing 19 may be fixed to the corresponding front side member 11 using fasteners, welding, and/or the like.

Referring to FIGS. 3-5, each front side member 11 may include at least one mounting bracket 20 protruding toward the interior of the vehicle, and the mounting bracket 20 may be mounted on the PE module 5. As illustrated in FIGS. 3-4, a pair of mounting brackets 20 may protrude from the inboard wall 11a of the front side member 11 toward the PE module 5.

The PE module 5 may have a pair of mounting lugs 5a protruding toward the pair of front side members 11, respectively. A mounting lug 5a, among the pair of mounting lugs 5a of the PE module 5, may be inserted between the pair of mounting brackets 20, and the mounting lug 5a of the PE module 5 may be mounted on the pair of mounting brackets 20. Because the pair of mounting lugs 5a are provided on both sides of the PE module 5, the PE module may connect the pair of front side members 11 through the mounting brackets 20 in the width direction of the vehicle so that the PE module 5 may define the lateral load path formed along the width direction of the vehicle.

Referring to FIGS. 3 to 5, the pair of mounting brackets 20 may be attached to the inboard wall 11a of the front side member 11, and the front side member 11 may further include a bulkhead 30 provided in the cavity of the front side member. The bulkhead 30 may be fixed to an inner surface of the inboard wall 11a of the front side member 11 and an inner surface of the outboard wall 11b by welding. The bulkhead 30 may be connected to the mounting bracket through the inboard wall 11a of the front side member 11, and the bulkhead 30 may be connected to the connection member 13 through the outboard wall 11b of the front side member 11. Accordingly, the bulkhead 30 positioned within the cavity of the front side member 11 may connect the mounting bracket 20 and the connection member 13, and the connection member 13 may transfer the load input from the front bumper 17 to the PE module 5 through the bulkhead 30 and the mounting bracket 20 (see dotted line L in FIG. 3) so that a load transfer direction may change from the longitudinal direction of the vehicle to the width direction of the vehicle through the connection member 13, the bulkhead 30, and the mounting bracket 20, and thus the lateral displacement of the vehicle may be stably induced in the event of a small overlap crash of the vehicle.

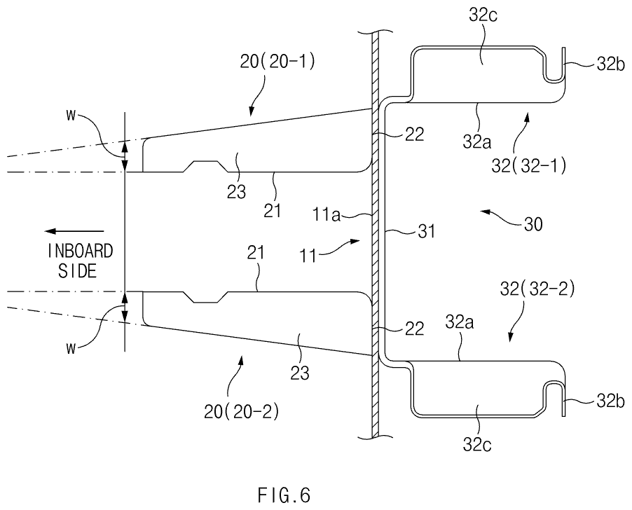

Referring to FIG. 6, the pair of mounting brackets 20 may be fixed to an outer surface of the inboard wall 11a of the front side member 11. Each mounting bracket 20 has a width w that may gradually decreases from the front side member 11 toward the PE module 5. The bulkhead 30 may be fixed to the inner surface of the inboard wall 11a of the front side member 11, and the bulkhead 30 may be aligned with the pair of mounting brackets 20. Accordingly, the bulkhead 30 may be connected to the pair of mounting brackets 20 through the inboard wall 11a of the front side member 11.

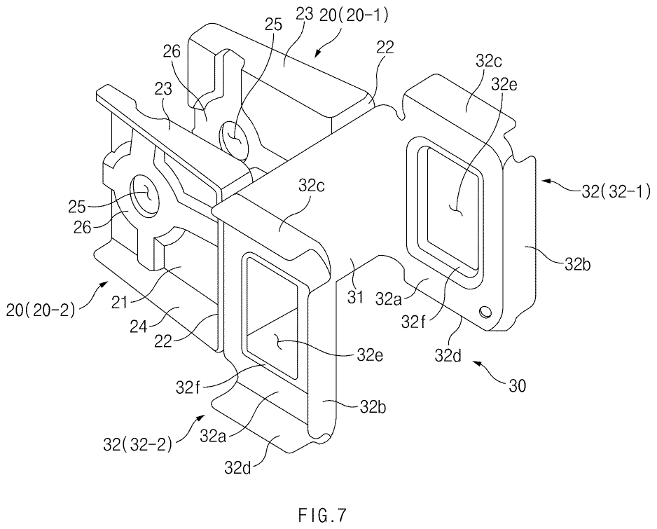

Referring to FIGS. 6 and 7, the pair of mounting brackets 20 may be spaced apart from each other in a longitudinal direction of the front side member 11, and the pair of mounting brackets 20 may include a front mounting bracket 20 (20-1) facing the front of the front side member 11 (the front of the vehicle), and a rear mounting bracket 20 (20-2) facing the rear of the front side member 11 (the rear of the vehicle). In other words, the rear mounting bracket 20-1 is positioned behind the front mounting bracket 20-2 along the longitudinal direction of the front side member 11.

Referring to FIG. 7, each mounting bracket (20-1, 20-2; collectively “20”) may include a support wall 21, and a mounting flange 22 connected to the support wall 21. The support wall 21 may extend from the inboard wall 11a of the front side member 11 toward the PE module (the interior of the vehicle), and the support wall 21 may have a flat surface perpendicular to a longitudinal axis of the front side member 11. The mounting flange 22 may be fixed to the outer surface of the inboard wall 11a of the front side member 11 using fasteners, welding, and/or the like, and the mounting flange 22 may be perpendicular to the support wall 21. In addition, each mounting bracket 20 may further include a top wall 23 connected to a top edge of the support wall 21, and a bottom wall 24 connected to a bottom edge of the support wall 21. The top wall 23 and the bottom wall 24 may be perpendicular to the support wall 21. A width of each of the top wall 23 and the bottom wall 24 may gradually decrease from the inboard wall 11a toward the interior of the vehicle and the PE module 5.

Each support wall 21 may have a mounting hole 25 configured to align with the mounting lug 5a of the PE module 5, and a fastener, a mounting pin, or similar securing component may be inserted through the mounting lug 5a of the PE module 5 and the mounting hole 25 of the support wall 21. Each support wall 21 may have a reinforcing bead 26 disposed around the circumference of the mounting hole 25. As illustrated in FIG. 7, in one embodiment, the reinforcing bead 26 may have a circular portion surrounding the mounting hole 25 and multiple straight portions extending outwardly from the circular portion. At least one straight portion, among the multiple straight portions, may extend from the circular portion toward the mounting flange 22.

Referring to FIG. 7, the bulkhead 30 may include a mounting plate 31, and a pair of support brackets 32 extending from the mounting plate 31.

The mounting plate 31 may be fixed to the inner surface of the inboard wall 11a of the front side member 11 using fasteners, welding, and/or the like. The mounting flanges 22 of the pair of mounting brackets 20 may be aligned with the mounting plate 31.

The support brackets 32 may extend from both side edges of the mounting plate 31 toward the outboard wall 11b of the front side member 11, respectively. The pair of support brackets 32 may be spaced apart from each other in the longitudinal direction of the front side member 11. The pair of support brackets 32 may be spaced apart from each other by a gap corresponding to a gap between the pair of mounting brackets 20. The pair of support brackets 32 may include a front support bracket 32 (32-1) facing the front of the front side member 11 (the front of the vehicle) and a rear support bracket 32 (32-2) facing the rear of the front side member 11 (the rear of the vehicle). The front support bracket 32 (32-1) may be aligned with the front mounting bracket 20 (20-1) in the width direction of the vehicle, and the rear support bracket 32 (32-2) may be aligned with the rear mounting bracket 20 (20-2) in the longitudinal direction of the vehicle.

Referring to FIG. 7, each support bracket 32 (32-1, 30-2; collectively “32”) may include a support wall 32a, and a mounting flange 32b connected to the support wall 32a.

The support wall 32a may extend from the mounting plate 31 toward the outboard wall 11b, and the support wall 32a may have a flat surface perpendicular to the front side member 11 which extends along the longitudinal direction of the vehicle. The mounting flange 32b may be fixed to the inner surface of the outboard wall 11b of the front side member 11 using fasteners, welding, and/or the like, and the mounting flange 32b may be perpendicular to the support wall 32a. In addition, each support bracket 32 may include a top wall 32c connected to a top edge of the support wall 32a, and a bottom wall 32d connected to a bottom edge of the support wall 32a. The top wall 32c and the bottom wall 32d may be perpendicular to the support wall 32a, the top wall 32c may be fixed to the top wall of the front side member 11 using fasteners, welding, and/or the like, and the bottom wall 32d may be fixed to the bottom wall of the front side member 11 using fasteners, welding, and/or the like. Each support wall 32a may have an opening 32e formed in the center thereof, and a reinforcing bead 32f provided along the circumference of the opening 32e.

The connection member 13, the bulkhead 30, the mounting bracket 20, and the PE module 5 may be connected so that the load transfer path may be defined by the connection member 13, the bulkhead 30, the mounting bracket 20, and the PE module 5 in the longitudinal direction of the vehicle and the width direction of the vehicle. Referring to FIG. 3, the inboard-side flange 13a of the connection member 13 may be aligned with the mounting flange 32b of the front support bracket 32. Accordingly, the inboard-side flange 13a of the connection member 13 may be connected to the mounting flange 32b of the front support bracket 32 through the outboard wall 11b of the front side member 11. The mounting flange 22 of the front mounting bracket 20 may be connected to the mounting plate 31 of the bulkhead 30 through the inboard wall 11a of the front side member 11. Because the connection member 13, the front support bracket 32 of the bulkhead 30, the front mounting bracket 20, and the PE module 5 may be structurally connected, the load during a small overlap crash of the vehicle may be transferred to the PE module 5 through the inboard-side flange 13a of the connection member 13, the front support bracket 32 of the bulkhead 30, and the front mounting bracket 20 (see dotted line L in FIG. 3).

As set forth above, the connection member 13 and the mounting bracket 20 may connect the mounting plate 12, the front side member 11, and the PE module 5 so that the load transfer direction may change from the longitudinal direction of the vehicle to the width direction of the vehicle in the event of a vehicle collision/impact, and thus the lateral displacement of the vehicle may be stably induced. In particular, the bulkhead 30 may connect the connection member 13 and the mounting bracket 20 in the cavity of the front side member 11 so that the load may be transferred to the PE module 5 more stably.

In addition, the front subframe 16 having the cross portion 16a extending in the width direction of the vehicle may be connected to the bottom end of the connection member 13 so that the load may be transferred to the cross portion 16a of the front subframe 16 in the event of a vehicle collision/impact, and thus the lateral displacement of the vehicle may be more stably induced.

According to embodiments of the present disclosure, in the event of a vehicle collision/impact, the lateral displacement of the vehicle may be stably induced through the connection member 13 and the mounting bracket 20 without additional components such as a cross bar made of an expensive aluminum material, a bumper deflector, and a side deflector, and thus the manufacturing cost and weight of the vehicle front structure may be significantly reduced, and space utilization of a front compartment of the vehicle may be increased. As the lateral displacement of the vehicle is stably induced, crashworthiness of the vehicle may be enhanced.

As set forth above, the vehicle front structure according to embodiments of the present disclosure may induce the lateral displacement of the vehicle through the connection member and the mounting bracket without additional components such as an expensive aluminum cross bar, a bumper deflector, and a side deflector in the event of a vehicle collision/impact, thereby significantly reducing the manufacturing cost and weight thereof, and increasing the space utilization of the front compartment of the vehicle. In addition, as the lateral displacement of the vehicle is stably induced, the crashworthiness of the vehicle may be enhanced.

Hereinabove, although the present disclosure has been described with reference to some embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. A vehicle front structure, comprising:
a front side member extending in a longitudinal direction of a vehicle;
a mounting plate attached to a front end of the front side member;
a connection member connecting the mounting plate and the front side member;
a mounting bracket protruding from the front side member toward an interior of the vehicle; and
a power electronics (PE) module connected to the mounting bracket.

2. The vehicle front structure according to claim 1, further comprising: a bulkhead disposed in the front side member and aligned with the mounting bracket.

3. The vehicle front structure according to claim 2, wherein an inboard-side flange of the connection member is fixed to an outboard wall of the front side member.

4. The vehicle front structure according to claim 3, wherein the inboard-side flange of the connection member is connected to the bulkhead.

5. The vehicle front structure according to claim 1, wherein a front bumper is connected to a front surface of the mounting plate, and
the front side member and the connection member are fixed to a rear surface of the mounting plate.

6. The vehicle front structure according to claim 1, wherein the mounting plate includes an inboard-side mounting portion facing the interior of the vehicle and an outboard-side mounting portion facing an exterior of the vehicle,
the front side member is fixed to the inboard-side mounting portion of the mounting plate, and
the connection member is fixed to the outboard-side mounting portion of the mounting plate.

7. The vehicle front structure according to claim 1, further comprising a front subframe connected to a bottom end of the connection member,
wherein the front subframe has a cross portion extending in a width direction of the vehicle.

8. The vehicle front structure according to claim 1, wherein the mounting bracket comprises:
a support wall extending from an inboard wall of the front side member toward the PE module, and
a mounting flange connected to the support wall, and
wherein the mounting flange is fixed to an outer surface of the inboard wall of the front side member.

9. The vehicle front structure according to claim 2, wherein the bulkhead includes:
a mounting plate fixed to an inner surface of an inboard wall of the front side member, and
a support bracket extending from the mounting plate of the bulkhead toward an outboard wall of the front side member.

10. The vehicle front structure according to claim 9, wherein the support bracket includes:
a support wall extending from the mounting plate of the bulkhead toward the outboard wall of the front side member, and
a mounting flange connected to the support wall, and
wherein the mounting flange is fixed to an inner surface of the outboard wall of the front side member.

11. The vehicle front structure according to claim 10, wherein an inboard-side flange of the connection member is connected to the mounting flange of the support bracket.

12. The vehicle front structure according to claim 1, wherein the mounting bracket has a width that gradually decreases from the front side member toward the PE module.

13. The vehicle front structure according to claim 2, wherein the connection member, the bulkhead, the mounting bracket, and the PE module are connected.

14. A vehicle front structure, comprising:
a front side member including an inboard wall and an outboard wall, each extending in a longitudinal direction of a vehicle and;
a mounting plate attached to a front end of the front side member;
a connection member connecting the mounting plate and the front side member;
at least one mounting bracket attached to the inboard wall in a direction perpendicular to the longitudinal direction of the vehicle and connected to a power electronics (PE) module; and
a bulkhead positioned within an interior space defined by the inboard wall and the outboard wall,
wherein the bulkhead is aligned with the at least one mounting bracket and configured to form a load path from a bumper to the PE module via the connection member and the mounting bracket.

15. The vehicle front structure according to claim 14, wherein an inboard-side flange of the connection member is fixed to the outboard wall of the front side member.

16. The vehicle front structure according to claim 15, wherein the inboard-side flange of the connection member is connected to the bulkhead.

17. The vehicle front structure according to claim 14, wherein the mounting plate includes an inboard-side mounting portion facing an interior of the vehicle and an outboard-side mounting portion facing an exterior of the vehicle,
the front side member is fixed to the inboard-side mounting portion of the mounting plate, and
the connection member is fixed to the outboard-side mounting portion of the mounting plate.

18. The vehicle front structure according to claim 14, further comprising a front subframe connected to a bottom end of the connection member such that an impact load is transferred from the bumper to the front subframe 16 through the connection member.

19. The vehicle front structure according to claim 14, wherein the connection member is configured to transfer a load input from the bumper to the PE module through the bulkhead and the at least one mounting bracket so that a load transfer direction during a vehicle collision is changed from the longitudinal direction of the vehicle to a width direction of the vehicle along the load path.

20. The vehicle front structure according to claim 14, wherein the at least one mounting bracket includes a pair of mounting brackets arrange along the longitudinal direction of the vehicle and a mounting lug of the PE module is rigidly secured between the pair of mounting brackets.
